(19) United States
(12) Patent Application Publication
(10) Pub. No.: US 2025/0392844 A1
(43) Pub. Date: Dec. 25, 2025

(54) SYSTEM FOR READING A CHARGE CONTAINED IN A PHOTODIODE OF A PIXEL AND ASSOCIATED METHOD

(71) Applicant: STMicroelectronics International N.V., Geneva (CH)

(72) Inventor: Laurent SIMONY, Grenoble (FR)

(73) Assignee: STMicroelectronics International N.V., Geneva (CH)

(21) Appl. No.: 19/240,371

(22) Filed: Jun. 17, 2025

(30) Foreign Application Priority Data
Jun. 19, 2024 (FR) FR2406537

(51) Int. Cl. H04N 25/78; H04N 25/60; H04N 25/709

(52) U.S. Cl. CPC H04N 25/78; H04N 25/60; H04N 25/709

(57) ABSTRACT

A pixel includes a photodiode, a supply input, an output and a reading node. A system for reading a charge contained in the photodiode of the pixel includes a biasing circuit configured to bias the output of the pixel. The output of the pixel is connected through a first switch to the biasing circuit. The supply input of the pixel is connected to an energy storage capacitor and to a first end of a second switch. A second end of the second switch is intended to be connected to a DC voltage source. A control circuit controls operation of the first and second switches whereby the pixel is disconnected by the second switch during digitization and powered from the energy storage capacitor.

### PRIORITY CLAIM

This application claims the priority benefit of French Application for Patent No. FR2406537, filed on Jun. 19, 2024, the content of which is hereby incorporated by reference in its entirety to the maximum extent allowable by law.

### TECHNICAL FIELD

Embodiments and implementations relate to the reading of a charge contained in a pixel.

### BACKGROUND

A matrix of pixels of a sensor includes pixels organized in rows and columns.

It is known that, when a pixel is supplied by a noisy supply signal, a signal representing the optical capture made by the pixel is noisy (“line noise”) so that the quality of the image generated from said signal is insufficient, causing an image fault.

In order to minimize the transmission of the noise of the supply signal, supplying the pixels from a voltage regulator connected to a supply source delivering a supply voltage is known. However, the voltage regulator causes a voltage drop so that the amplitude of the signal delivered by the pixels is reduced. Furthermore, the voltage regulator causes an increase in energy consumption and requires providing a space for installation thereof on an integrated circuit generally including the matrix of pixels.

Thus, there is a need to eliminate the voltage regulator while minimizing the line noise so that the image generated from the signal delivered by the pixel is of sufficient quality.

### SUMMARY

Embodiments and implementations herein allow reading of the charge contained in a pixel while minimizing the line noises without the implementation of a voltage regulator.

According to one aspect, a method is proposed for reading a charge contained in a photodiode of a pixel, wherein the pixel includes: a supply input; an output; a reading node; wherein the output of the pixel is connected through a first switch to a circuit for biasing the output of the pixel; a follower transistor including a gate connected to the reading node and a drain connected to the supply input; and a reading transistor connecting a source of the follower transistor to the output of the pixel; wherein the supply input is connected to an energy storage capacitor and further connected through a second switch to a first DC voltage source.

The method includes: first digitizing step for digitizing a first value of the potential of the reading node; transferring the charge contained in the photodiode to the reading node following the first digitizing; second digitizing step for digitizing a second value of the potential of the reading node including the transferred charge; wherein each of the first and second digitizing steps include: closing the second switch to charge the energy storage capacitor; simultaneously with the closure of the second switch, closing the first switch followed by opening the first switch when the output voltage of the pixel is established to within establishment precision; opening the second switch following the opening of the first switch; and digitizing the value of the potential of the reading node on the output of the pixel when the first and second switches are open, with the pixel being supplied by the storage capacitor.

The readings of the output signal of the pixel are made when the supply switch is open so that the line noises transmitted by the DC supply source are not transmitted to the pixel, the pixel being supplied by the energy storage capacitor. The pixel is disconnected from the supply provided by the first DC voltage source during the reading of the output signals of the pixel.

Advantageously, the voltage regulator known from the prior art is eliminated without impairing the quality of the signals delivered by the pixel. Furthermore, as the voltage regulator consuming electrical power is eliminated, the electrical energy delivered by the supply source is reduced. Furthermore, as the voltage regulator is eliminated, the voltage drop due to the regulator is eliminated and the output amplitude of the signal can be increased to gain in signal-to-noise ratio.

According to an embodiment, the circuit for biasing includes a current source and, the reading transistor is closed during the first and second digitizing steps, the method further comprising, for each of the first and second digitizing steps, closing the first switch for a stabilization period making it possible to establish the output voltage of the pixel to within a required precision.

According to one embodiment, the period between the opening of the first switch and the opening of the second switch is identical during the first and second digitizing steps.

According to one embodiment, the circuit for biasing includes a voltage source, the method further including, for each of the first and second digitizing steps, closing the first switch until a required establishment precision is achieved, opening the first switch when said precision is achieved, and closing the reading transistor.

According to one implementation, the period between the closing of the reading transistor and the opening of the second switch is identical during the first and second digitizing steps.

According to another aspect, a system is proposed for reading a charge contained in a photodiode of a pixel, wherein the pixel includes: a supply input; an output; a reading node; a reading system including a circuit for biasing the output of the pixel; a first switch; an energy storage capacitor; and a control circuit; wherein the output of the pixel is connected through the first switch to the circuit for biasing; the pixel further comprising: a follower transistor including a gate connected to the reading node and a drain connected to the supply input; a reading transistor connecting the source of the follower transistor to the output of the pixel; the supply input being connected to the energy storage capacitor and to a first end of the second switch; the second end of the second switch being intended to be connected to a DC voltage source; and a control circuit configured to: during a first digitizing step, implement a first digitizing of a first value of the potential of the reading node; transfer the charge contained in the photodiode to the reading node following the first digitizing; during a second digitizing step, implement a second digitizing of a second value of the potential of the reading node including the transferred charge; during each of the first and second digitizing step, the control circuit is further configured to: close the second switch to charge the energy storage capacitor; simultaneously with the closure of the second switch, close the first switch followed by opening the first switch following the closure of the first switch when the output voltage of the pixel is established to within a required establishment precision; open the second switch following the opening of the first switch; and wherein each of the first and second digitizing of the value of the potential of the reading node on the output of the pixel are implemented when the first and second switches are open; an wherein the pixel is supplied by the storage capacitor.

According to one implementation, the circuit for biasing includes a current source, wherein the control circuit is configured to close the reading transistor, and, for each of the first and second digitizing, close the first switch during a stabilization period for establishing the output voltage of the pixel to within a required precision.

According to one embodiment, the period between the opening of the first switch and the opening of the second switch is identical during the first and second digitizing steps.

According to one embodiment, the circuit for biasing includes a voltage source, wherein the control circuit is configured, for each of the first and second digitizing step, to close the first switch until a required establishment precision is achieved, to open the first switch when said precision is achieved, and to close the reading transistor.

According to one embodiment, the period between the closing of the reading transistor and the opening of the second switch is identical during the each of the first and second digitizing steps.

According to yet another aspect, a column of pixels is proposed including a system as defined above and at least one second pixel identical to the first pixel, the output of the second pixel being connected to the circuit for biasing through the first switch, the supply input of the second pixel being connected to the energy storage capacitor and to the first end of the second switch.

According to another aspect, a matrix of pixels is proposed, including at least one first column of pixels as defined above and a second column of pixels as defined above.

According to one embodiment, the energy storage capacitor of the first column of pixels and the energy storage capacitor of the second polymer pixels are grouped together in a common storage capacitor.

### BRIEF DESCRIPTION OF THE DRAWINGS

Other advantages and features of the invention will become apparent upon examining the detailed description of non-limiting embodiments and implementations, and from the accompanying drawings, wherein figures:

FIG. 1 is a schematic diagram of an integrated circuit including a column of pixels and a converter;

FIG. 2 is a timing diagram of an example of a reading method implementing the digitization system shown in FIG. 1;

FIG. 3 is a schematic diagram of a second example of an integrated circuit including a column of pixels and a converter;

FIG. 4 is a timing diagram of an example of a reading method implementing the digitization system shown in FIG. 3;

FIG. 5 illustrates a first example of a matrix of pixels; and

FIG. 6 illustrates a second example of a matrix of pixels.

### DETAILED DESCRIPTION

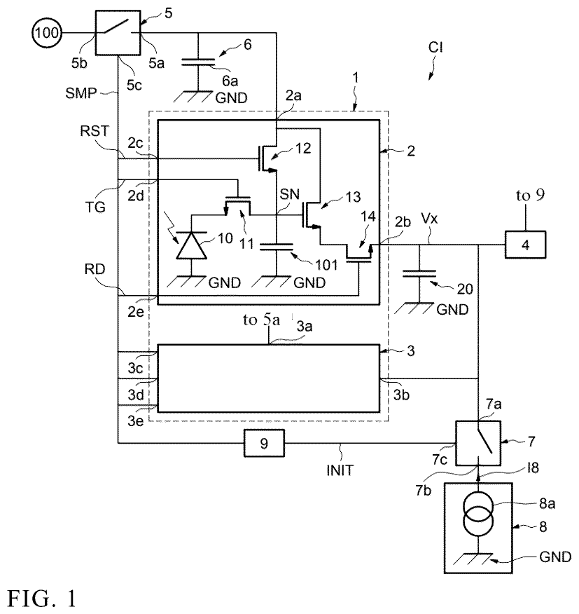

FIG. 1 schematically illustrates a first example of an integrated circuit CI including a column 1 of pixels and a converter 4. The column 1 comprises a plurality of identical pixels 2, 3. For reasons of clarity, only two pixels 2, 3 are shown. Naturally, the column 1 can include more than two pixels.

The integrated circuit CI further includes a first switch 7, a second switch 5, an energy storage capacitor 6, a biasing circuit 8 and a control circuit 9.

A capacitor 20 is connected between the output 2b of the first pixel 2 and ground GND.

The converter 4 is controlled by the control circuit 9.

A first end 5a of the second switch 5 is connected to the storage capacitor 6 and to a supply input 2a, 3a of each pixel 2, 3 of the column 1. The second end 5b of the second switch 5 is connected to a DC voltage source 100.

The first switch 5 further includes a control input controlled by the control circuit 9. A first end 7a of the first switch 7 is connected to an output 2b, 3b of each pixel 2, 3 of the column 1. A second end 7b of the first switch 7 is connected to the biasing circuit 8.

The first switch 7 is controlled by the control circuit 9.

The biasing circuit 8 includes a current source 8a delivering a current 18.

Each pixel 2, 3 further comprises an initialization input 2c, 3c, a charge transfer input 2d, 3d and a reading input (line selection) 2e, 3e. The initialization inputs 2c, 3e, charge-transfer inputs 2d, 3d and reading inputs 2e, 3e are controlled by the control circuit 9.

As the pixels 2, 3 are identical, only a first pixel 2 is detailed hereinafter.

The first pixel 2 comprises a pinched photodiode 10 including an anode connected to ground GND and a charge transfer transistor 11 including a source connected to the cathode of the photodiode 10, a drain connected to a floating reading node SN of the first pixel 2 and a gate connected to the transfer input 2d.

The first pixel 2 further includes an initialization transistor 12 including a drain connected to the supply input 2a of the first pixel 2, a source connected to the reading node SN and a gate connected to the initialization input 2c.

In a variant, the drain of the initialization transistor 12 can be connected to a voltage source different from the DC voltage source 100.

The first pixel 2 includes a capacitor 101 connected between the floating reading node SN and ground GND.

The first pixel 2 further includes a follower transistor 13 including a drain connected to the supply input 2a of the first pixel 2, and a gate connected to the floating reading node SN.

The first pixel 2 further includes a reading transistor 14 including a drain connected to the source of the follower transistor 13, a source connected to the output 2b of the first pixel 2 and a gate connected to the reading input 2e of the first pixel 2.

The transfer 11, initialization 12 and reading 14 transistors are, for example, field-effect transistors of the metal-oxide-semiconductor (MOS) isolated gate field-effect transistor (FET) type, doping type N, referred to as an NMOS transistor, the first pixel 2 including four transistors.

The embodiment disclosed herein applies to any pixel including at least one pinched photodiode, a transfer transistor, an initialization transistor, a reading transistor and a follower transistor of the NMOS type.

The pixels 2, 3, the energy storage capacitor 6, the biasing circuit 8, the converter 4, the first switch 7, the second switch 5 and the control circuit 9 form a system for reading a charge contained in a photodiode 10 of the pixels 2, 3 of the column 1.

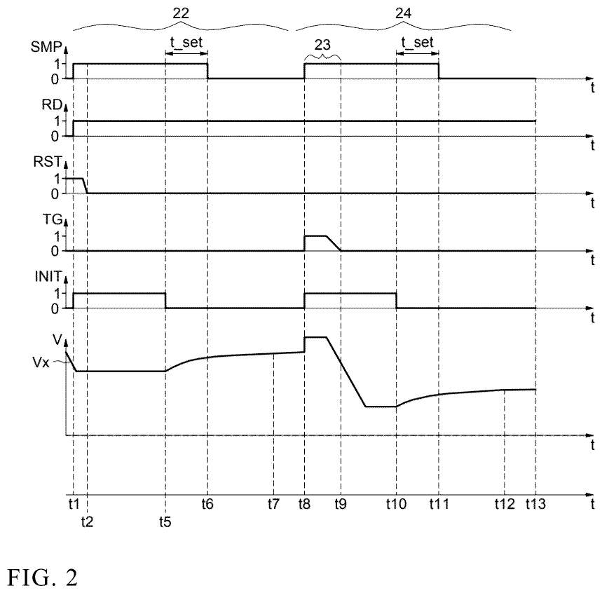

FIG. 2 illustrates a timing diagram of an example of a reading method implementing the digitization system illustrated in FIG. 1.

It is supposed hereinafter that only the charge contained in the photodiode 10 of the first pixel 2 is read.

As referenced herein, a closed transistor is turned on and an open transistor is not turned on.

Naturally, the reading of the value of the charge contained in the photodiode 10 as a digital code as described hereinafter applies to all the pixels in the column 1.

The timing diagram illustrates an example of change over time of control signals SMP, INIT, TG, RST, RD delivered by the control circuit 9, and of the signal V_{X} delivered on the output 2b of the pixel 2.

The control signal for the second switch 5 is denoted SMP, the control signal for the first switch 7 is denoted INIT, the control signal for the transfer transistor 11 is denoted TG, the control signal for the initialization transistor 12 is denoted RST and the control signal for the reading transistor 14 is denoted RD.

The method includes the selection of the first pixel 2 by the passing to the high state of the signal RD applied to the reading input 2d of said pixel 2, a first step 22 of digitizing a first value of the potential of the reading node SN, a transfer of the charge 23 contained in the photodiode 10 to the reading node SN following the first digitization, and a second step 24 of digitizing a second value of the potential of the reading node SN including the transferred charge.

Digitization steps 22, 24 are implemented by the converter 4.

Each of the first and second digitization steps 22, 24 includes the following operation steps: closing the second switch 5 to charge the energy storage capacitor 6; and simultaneously with the closure of the second switch 5, closing the first switch 7 and opening the first switch when the output voltage of the pixel is established to within a given precision (wherein establishing the output voltage of the pixel to within a required precision constitutes a determinist initial condition essential for obtaining an output signal of the pixel 2, determinist by difference of the first and second digitization steps 22, 24); opening the second switch 5 following the opening of the first switch 7; and digitizing the value of the potential of the reading node SN on the output 2b of the pixel when the first and second switches 5 are open, wherein the pixel is supplied with power by the storage capacitor.

The digitizations of the output signal of the pixel are implemented when the supply switch is open so that the noises transmitted by the DC supply source are not transmitted to the pixel, the pixel instead being supplied by power through the energy storage capacitor. The pixel is disconnected from the supply provided by the first DC voltage source during the reading of the output signals of the pixel preventing the creation of a line noise due to the noise of the source 100.

And advantage of this implementation is that the voltage regulator known from the prior art is eliminated without impairing the quality of the signals delivered by the pixel. Furthermore, as the voltage regulator is eliminated, the voltage drop due to the regulator is eliminated and the output amplitude of the signal can be increased to gain in signal-to-noise ratio.

The given precision margin is determined so as not to degrade the quality of the image sought.

The first and second digitization steps 22, 24 and the transfer step 23 are now detailed.

During the first digitization step 22, at an instant t1, the second switch 5 is closed (SMP at the high state) to charge the storage capacitor 6 and to supply the pixels in the column 1, the first switch 7 is closed (signal INIT at the high state), the initialization transistor 12 is closed (RST at the high state) to initialize the reading node SN of the first pixel 2 and the reading transistor 14 is closed (RD at the high state).

At an instant t2, the initialization transistor 12 is open (RST at the low state).

At an instant t5, when the output voltage V_{X} of the pixel 2 is established to within a required establishment precision, the first reinitialization switch 7 is open (INIT at the low state).

The establishment precision is predetermined from the precision required for the sensor.

Between the instants t1 and t5, the reading transistor 14 and the first switch 7 are simultaneously closed for an establishment period making it possible to establish, to within the required establishment precision, the output voltage V_{X} of the first pixel 2.

As from the instant t5, the current consumed by the pixel 2 decreases rapidly. When the current consumed by the first pixel 2 is sufficiently low to be able to be delivered by the storage capacitor 6 as assessed by a person skilled in the art, at an instant t6, the second supply switch 5 is open (SMP at the low state). The pixels 2, 3 are supplied by the storage capacitor 6.

The period between the opening of the first switch 7 following the closure of the first switch 7 (instant t5) and the opening of the second switch 5 (instant t6) is referenced t_set. The current consumed by the pixel 2 corresponds to the charge of the capacitor 20 connected to the output 2b of the first pixel 2 by the follower transistor 13. The current consumed decreases rapidly over time. The period t_set is selected so that the current necessary for supplying the first pixel 2 during the digitization period can be delivered by the energy storage capacitor 6 without debiasing the follower transistor 13 of the first pixel 2.

At an instant t7 during a first digitization of the first digitization step 22, following the instant t6, the converter 4 digitizes the signal V_{X} representing a first value of the potential of the reading node SN and a shift of the system.

When the output signal of the converter 4 representing the reference potential of the signal SN is delivered, the charge transfer step 23 and the second digitization step 24 begin at an instant t8.

At the instant t8, the second switch 5 is closed to charge the storage capacitor 6 and to supply the pixels in the column 1, the second switch 7 is closed, and the transfer transistor 11 is on (TG at the high state) to transfer the charge contained in the photodiode 10 to the reading node SN.

At an instant t9, when the charge has been transferred from the photodiode 10 to the node SN, the transfer transistor 11 is open (TG at the low state).

At an instant t10, when the output voltage V_{X} of the pixel 2 is established to within the required establishment precision, the first switch 7 is open.

At an instant t11, the second switch 5 is open. The pixels 2, 3 are supplied by the storage capacitor 6.

The period between the opening of the first switch 7 following the closure of the first switch 7 (instant t10) and the opening of the second switch 5 (instant t11) is equal to the period t_set between the instants t5 and t6.

The period t_set makes it possible to obtain a current consumed by the first pixel 2 that is sufficiently low so that the storage capacitor 6 is able to supply the first pixel 2 without desaturating the follower transistor 13.

The equality of the periods between the instants t5 and t6 and between the instants t10 and t11 makes it possible to guarantee identical changes in the signal V_{X} of the pixel 2 as from the instants t5 and t10 to prevent the appearance of voltage shifts during the determination of the difference between the two digitizations by the converter 4.

At an instant t12, when the second supply switch 5 is open (SMP at the low state), the converter 4 digitizes the signal V_{X} representing a second value of the potential of the reading node SN including the transferred charge and a shift of the system.

For example, the instant t12 is defined so that the period between the instants t7 and t6 is equal to the period between the instants t11 and t12.

The required establishment precision at the instants t5 and t10 defines respectively the precision of the signal obtained by difference of the signal V_{X} at the instants t7 and t12.

In a known manner, the converter 4 can further make the subtraction between the results of the first and second digitizations (referenced as a correlated double sampling operation) so that the shift of the system is eliminated and the result is proportional to the charge transferred during step 23.

The period between the instants t5 and t6 is, for example, equal to the period between the instants t10 and t11.

From the signals V_{X} delivered during the first and second digitizations, the value of the charge stored in the photodiode 10 when a light signal is captured by said diode is digitized.

The capacitor 6, the period between the instants t1 and t6 and the period between the instants t8 and t11 are selected so that the capacitor 6 is able to supply the pixels 2, 3 when the second switch 5 is open.

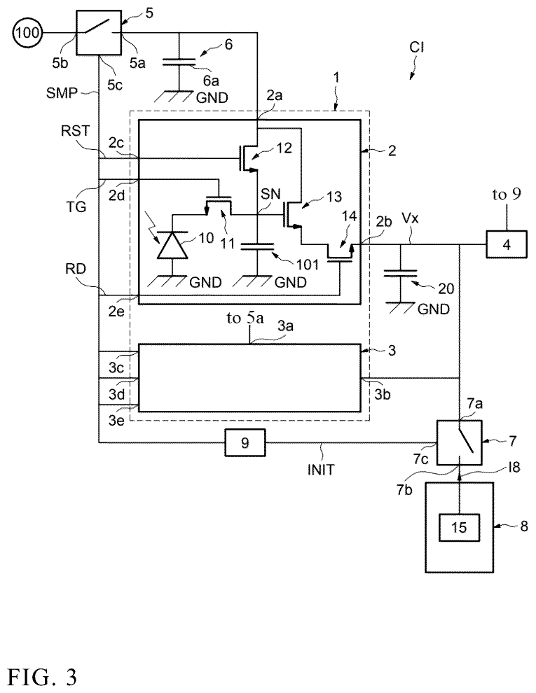

FIG. 3 illustrates a second example of the integrated circuit CI.

The second embodiment of the integrated circuit CI differs from the first example of the integrated circuit CI illustrated in FIG. 1 in that the integrated circuit CI includes a second embodiment of the biasing circuit 8, the biasing circuit 8 including a voltage source 15 connected to the second end 7b of the first switch. The voltage source 15 delivers a voltage that may, for example, be zero.

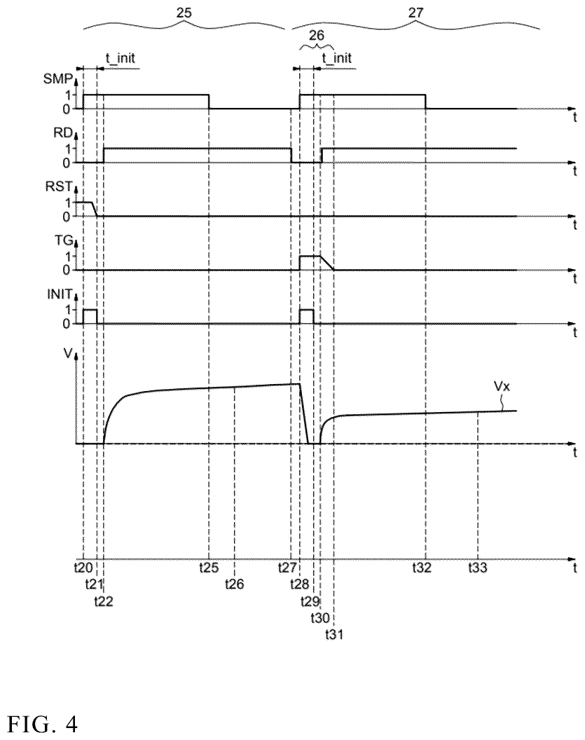

FIG. 4 illustrates a timing diagram of an example of the reading method implementing the digitization system illustrated in FIG. 3 of the second example of the integrated circuit CI.

It is supposed hereinafter that only the charge contained in the photodiode 10 of the first pixel 2 is read.

The timing diagram illustrates an example of change over time of the control signals SMP, INIT, TG, RST, RD.

The method includes a first step 25 of digitizing a first value of the potential of the reading node SN, a transfer of the charge 26 contained in the photodiode 10 to the reading node SN following a first digitization of the first digitization step 25, and a second digitization of a second digitization step 27 of a second value of the potential of the reading node SN including the transferred charge.

The first and second digitizations are implemented by the converter 4.

Each of the first and second digitization steps 25, 27 includes: closing the second switch 5 to charge the energy storage capacitor 6; simultaneously with the closure of the second switch 5, closing the first switch 7 and opening the first switch when the output voltage of the pixel is established; closing the reading switch 14 (controlled by RD), this closure having to be non-overlapping with that of the switch 7; opening the second switch 5 following the opening of the first switch 7; and digitizing the value of the potential of the reading node SN on the output 2b of the pixel when the first and second switches 5 are open, the pixel being supplied by the storage capacitor 6.

As described previously, the readings of the output signal of the pixel are made when the supply switch is open so that the line noises transmitted by the DC supply source are not transmitted to the pixel, with the pixel being supplied power by the energy storage capacitor. The pixel is disconnected from the supply provided by the first DC voltage source during the reading of the output signals of the pixel.

Advantageously, the voltage regulator known from the prior art is eliminated without impairing the quality of the signals delivered by the pixel. Furthermore, as the voltage regulator consuming electrical power is eliminated, the electrical energy delivered by the supply source is reduced. Furthermore, as the voltage regulator is eliminated, the voltage drop due to the regulator is eliminated and the output amplitude of the signal can be increased to gain in signal-to-noise ratio.

The first and second digitization steps 25, 27 and the transfer step 26 are now detailed.

During the first digitization step 25, at an instant t20, the second switch 5 is closed to charge the storage capacitor 6 and to supply the pixels in the column 1, the first switch 7 is closed to initialize Vx to ground GND, and the initialization transistor 12 is closed to initialize the reading node SN of the first pixel 2.

Furthermore, the transfer transistor 11 is open (TG at the low state and the reading transistor 14 is open.

At an instant t21, when the output voltage V_{X} of the pixel 2 is established at the voltage imposed by the voltage generator 15 to within a required establishment precision, the first reinitialization switch 7 is open (INIT at the low state). The establishment precision is predetermined from the precision required for the sensor.

The period of closure of the reinitialization switch 7 between the instants t20 and t21 is referenced t_init.

At an instant t22, when the initialization transistor 12 is open, the reading transistor 14 is closed (signal RD).

The reading switch 14 is closed following the opening of the first switch 7 so that the first switch and the reading switch 14 are not closed simultaneously (without overlap) to prevent a direct electrical connection between the source 100 and ground GND.

The following transistor 13 recharges the capacitor 20 through the reading transistor 14 to a voltage representing the potential of the node SN.

At an instant t25, when the capacitor 6 is able to supply the pixels 2, 3 between the instants t22 and an instant t28, the second switch 5 is open. The pixels 2, 3 are supplied by the storage means 6.

At an instant t26 between the instant t25 and an instant t27, the converter 4 digitizes the signal V_{X} representing a first value of the potential of the reading node SN and a shift of the system.

The first digitization of the first digitization step 25 is implemented at the instant t26 between the instants t25 and t27.

When the output signal of the converter 4 representing the reference potential of the signal SN is delivered, at the instant t26, the reading transistor 14 is open.

The charge transfer step 26 and the second digitization step 27 begin at the instant t28.

At the instant t28, the second switch 5 is closed to charge the storage capacitor 6 and to supply the pixels in the column 1, the first switch 7 is closed, and the transfer transistor 11 is closed to transfer the charge contained in the photodiode 10 to the reading node SN.

The reading switch 14 is open before the first switch 7 is closed so that the first switch 7 and the reading switch 14 are not closed simultaneously (without overlap).

At an instant t29, the first switch 7 is open.

The period between the closing of the reading transistor 14 and the opening of the second switch 5 is identical during the first and second digitizations.

At an instant t30 following t29, the reading transistor 14 is closed.

At an instant t31, when the charge has been transferred from the photodiode 10 to the node SN, the transfer switch 11 is open.

At an instant t32, the second supply switch 5 is open. The pixels 2, 3 are supplied by the storage capacitor 6.

At an instant t33, when the second supply switch 5 is open (SMP at the low state), the converter 4 digitizes the signal V_{X} representing a second value of the potential of the reading node SN including the transferred charge.

The second digitization of the second digitization step 27 is implemented at the instant t33.

In a known manner, the converter 4 can further make the subtraction between the results of the first and second digitizations (referenced as a correlated double sampling operation) so that the shift of the system is eliminated and the result is proportional to the charge transferred during step 26.

The period between the instants t22 and t25 is equal to the period between the instants t30 and t32.

The period between the instants t25 and t26 is equal to the period between the instants t32 and t33.

From the signals V_{X} delivered during the first and second digitizations, the value of the charge stored in the photodiode 10 when a light signal is captured by said diode is determined.

The readings of the output signal of the first pixel 2 are made when the supply switch 5 is open so that the line noises transmitted by the source 100 are not transmitted to the pixels 2, 3, the pixels 2, 3 being supplied by the means 6.

Advantageously, the voltage regulator known from the prior art is eliminated without impairing the quality of the signals delivered by the pixels 2, 3. As the voltage regulator is eliminated, the amplitude of variation of the signal (“swing”) output from the pixel is increased and consequently the signal-to-noise ratio of said signal is increased.

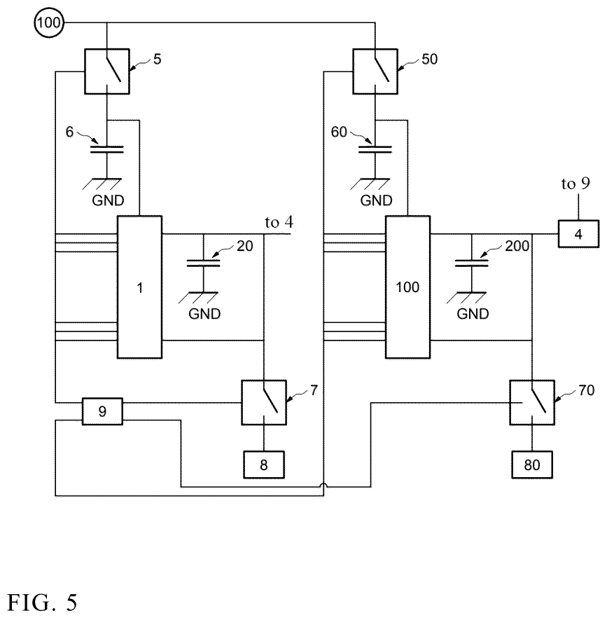

FIG. 5 illustrates a first example of a matrix of pixels. The matrix includes the first column 1 of pixels and a second column 100 of pixels identical to the first column 1. Naturally the matrix of pixels can comprise more than two columns of pixels.

The first column 1 of pixels is connected to the first and second switches 5, 7, to the storage capacitor 6, to the biasing circuit 8, to the control circuit 9, to the capacitor 20 and to the converter 4 as described previously.

The second column 100 of pixels is connected to first and second switches 50, 70, to a storage capacitor 60, to biasing circuit 80, to the control circuit 9, to a capacitor 200 and to the converter 4.

The first switch 70 connects the biasing circuit 80 to the outputs of the pixels in the second column 100 and is controlled by the control circuit 9, and the capacitor 200 connects the outputs of the pixels in the second column 100 to ground GND. The outputs of the pixels are further connected to the converter 4.

The second switch 50 connects the source 100 to the supply inputs of the pixels in the second column 10 and is controlled by the control circuit 9.

The supply inputs of the pixels in the second column 100 are further connected to ground GND by means of the storage capacitor 60.

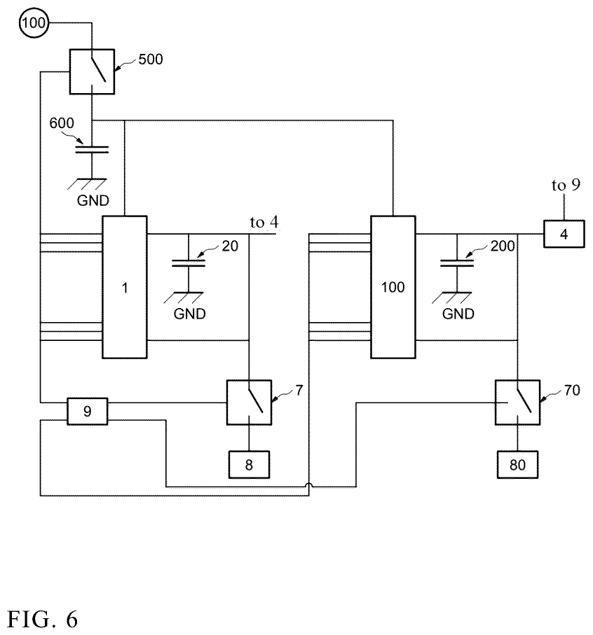

FIG. 6 illustrates a second example of a matrix of pixels. The second example differs from the first example of the matrix illustrated in FIG. 5 in that the supply inputs of the pixels in the second column 100 are connected to the supply inputs of the pixels in the first column 1, the matrix including a second switch 500 common to the columns 1, 2 and a storage capacitor 600 common to the columns 1, 2, the common storage capacitor 600 grouping together the storage capacitors 6 and 60 of the first and second columns 1, 10.

1. A method for reading a charge contained in a photodiode of a pixel, wherein the pixel includes: a supply input; an output; a reading node; wherein the output of the pixel is connected through a first switch to a circuit for biasing the output of the pixel; a follower transistor including a gate connected to the reading node and a drain connected to the supply input; and a reading transistor connecting a source of the follower transistor to the output of the pixel; wherein the supply input is connected to an energy storage capacitor and further connected through a second switch to a first DC voltage source, the method including:
first digitizing a first value of a potential of the reading node;
transferring charge contained in the photodiode to the reading node following the first digitizing step;
second digitizing a second value of the potential of the reading node including the transferred charge;
wherein each of the first digitizing and second digitizing includes:
closing the second switch to charge the energy storage capacitor;
simultaneously with the closure of the second switch, closing the first switch followed by opening the first switch when the output voltage of the pixel is established to within a required establishment precision;
opening the second switch following the opening of the first switch; and
digitizing the value of the potential of the reading node on the output of the pixel when the first and second switches are open, wherein the pixel is supplied power by the storage capacitor.

2. The method according to claim 1, wherein the biasing circuit includes a current source and the reading transistor is closed during first digitizing and second digitizing, the method further comprising, for each of the first digitizing and second digitizing, closing the first switch for a stabilization period making it possible to establish the output voltage of the pixel to within a required precision.

3. The method according to claim 2, wherein a period between the opening of the first switch and opening of the second switch is identical during each of the first digitizing and second digitizing.

4. The method according to claim 1, wherein the biasing circuit includes a voltage source, the method further comprising: for each of the first digitizing and second digitizing, closing the first switch until a required establishment precision is achieved; opening the first switch when said precision is achieved; and closing the reading transistor.

5. The method according to claim 4, wherein a period between opening the first switch and opening the second switch is identical during each of the first digitizing and second digitizing.

6. A system for reading a charge contained in a photodiode of a pixel, wherein the pixel includes: a supply input; an output; a reading node; a follower transistor including a gate connected to the reading node and a drain connected to the supply input; and a reading transistor connecting the source of the follower transistor to the output of the pixel, comprising:
a biasing circuit configured to bias the output of the pixel, wherein the output of the pixel is connected through a first switch to the biasing circuit;
an energy storage capacitor wherein the supply input is connected to the energy storage capacitor and further connected to a first end of a second switch, with a second end of the second switch configured for connection to a DC voltage source; and
a control circuit configured to:
during a first digitization, digitize a first value of a potential of the reading node;
transfer charge contained in the photodiode to the reading node following the first digitization; and
during a second digitization, digitize a second value of the potential of the reading node including the transferred charge;
wherein during each of the first digitization and second digitization, the control circuit is further configured to:
close the second switch to charge the energy storage capacitor;
simultaneously with the closure of the second switch, close the first switch and then open the first switch following the closure of the first switch when the output voltage of the pixel is established to within a required establishment precision;
open the second switch following the opening of the first switch; and
digitize the value of the potential of the reading node on the output of the pixel when the first and second switches are open, wherein the pixel is supplied power by the storage capacitor.

7. The system according to claim 6, wherein the biasing circuit includes a current source, and the control circuit is configured to:
close the reading transistor; and
for each of the first digitization and second digitization, close the first switch during a stabilization period for establishing the output voltage of the pixel to within a required precision.

8. The system according to claim 7, wherein a period between the opening of the first switch and the opening of the second switch is identical during each of the first digitization and second digitization.

9. The system according to claim 6, wherein the biasing circuit includes a voltage source, and the control circuit is configured, for each of the first digitization and second digitization, to:
close the first switch until a required establishment precision is achieved;
open the first switch when said precision is achieved; and
close the reading transistor.

10. The method according to claim 9, wherein a period between the closing of the reading transistor and the opening of the second switch is identical during each of the first digitization and second digitization.

11. A column of pixels including the system according to claim 6, comprising at least one second pixel identical to the first pixel, wherein an output of the second pixel is connected to through the first switch to the biasing circuit, wherein the supply input of the second pixel is connected to the energy storage capacitor and to the first end of the second switch.

12. A matrix of pixels including first and second columns of pixels according to claim 11.

13. The matrix according to claim 12, wherein the energy storage capacitor of the first column of pixels and the energy storage capacitor of the second column of pixels are grouped together in a common storage capacitor.
